(19) United States
(12) Patent Application Publication
(10) Pub. No.: US 2015/0145921 A1
(43) Pub. Date: May 28, 2015

(54) RECORDING APPARATUS AND RECORDING METHOD

(71) Applicant: SEIKO EPSON CORPORATION, Tokyo (JP)

(72) Inventor: Yuichi WASHIO, Matsumoto (JP)

(21) Appl. No.: 14/476,314

(22) Filed: Sep. 3, 2014

(30) Foreign Application Priority Data
Nov. 28, 2013 (JP) 2013-246398

(51) Int. Cl. B41J 11/00

(52) U.S. Cl. CPC B41J 11/0015
USPC 347/21

(57) ABSTRACT

The invention includes an aggregating agent coating section configured and arranged to apply an aggregating agent in a form of a powder to a recording medium and an ink discharge section configured and arranged to discharge an ink that is aggregated by the aggregating agent onto the recording medium to which the aggregating agent is applied. According to this configuration, applying the aggregating agent in the form of a powder the recording medium makes it possible to apply the aggregating agent to the recording medium without having to apply a treatment liquid that contains the aggregating agent to the recording medium. As such, the need for a step for drying a recording medium, which has been performed in instances where a treatment liquid was applied to the recording medium, is obviated.

### CROSS-REFERENCE TO RELATED APPLICATIONS

This application claims priority to Japanese Patent Application No. 2013-246398 filed on Nov. 28, 2013. The entire disclosure of Japanese Patent Application No. 2013-246398 is hereby incorporated herein by reference.

### BACKGROUND

1. Technical Field

The present invention relates to a recording apparatus and recording method with which ink is discharged to record onto a recording medium.

2. Related Art

There is a conventionally known inkjet recording apparatus that is provided with a treatment liquid application section for applying a treatment liquid for aggregating ink onto a coated paper for printing, a treatment liquid drying section for drying the coated paper for printing onto which the treatment liquid has been applied, and an ink droplet ejection section for ejecting droplets of liquid ink onto the coated paper for printing onto which the treatment liquid has been applied (see Japanese laid-open patent publication No. 2010-099968).

The inkjet recording apparatus is one where a treatment liquid containing an aggregating agent is applied to a recording medium, and is not one where the recording medium is coated with an aggregating agent in the form of a powder.

### SUMMARY

The present invention addresses the problem of providing a recording apparatus and recording method that obviate the need for a step for drying a recording medium, which has been performed in instances where a treatment liquid was applied to the recording medium.

A recording apparatus of the invention is characterized by being provided with an aggregating agent applying section configured and arranged to apply an aggregating agent in the form of a powder to a recording medium, and an ink discharge section configured and arranged to discharge ink that is aggregated by the aggregating agent onto the recording medium to which the aggregating agent is applied.

A recording method of the invention is characterized by comprising applying an aggregating agent in the form of a powder to a recording medium, and discharging ink that is aggregated by the aggregating agent onto the recording medium to which the aggregating agent is applied.

According to this configuration, applying the aggregating agent in the form of a powder to the recording medium makes it possible to apply the aggregating agent to the recording medium without having to apply a treatment liquid that contains the aggregating agent to the recording medium.

As such, the need for a step for drying a recording medium, which has been performed in instances where a treatment liquid was applied to the recording medium, is obviated.

In such a case, preferably, the aggregating agent applying section has an electrifying section configured and arranged to electrify the aggregating agent.

According to this configuration, the electrified aggregating agent is attracted to the recording medium, due to electrostatic attraction. This makes it possible to efficiently apply the aggregating agent to the recording medium.

In such a case, preferably, the aggregating agent applying section has an aggregating agent spraying section configured and arranged to spray the aggregating agent toward the recording medium.

According to this configuration, the spraying of the aggregating agent onto the recording medium by the aggregating agent spraying section makes it possible to apply properly the aggregating agent to the recording medium.

In such a case, preferably, the recording apparatus is further provided with an aggregating agent recovery section configured and arranged to suction and recover from the recording medium the aggregating agent that remains on the recording medium after the ink has been discharged from the ink discharge section.

According to this configuration, the aggregating agent recovery section makes it possible to recover the aggregating agent that remains on the recording medium.

In such a case, preferably, the aggregating agent recovery section has a neutralizing section configured and arranged to remove static electricity with which the aggregating agent has been electrified.

According to this configuration, the aggregating agent that remains on the recording medium can be efficiently recovered, because the static electricity with which the aggregating agent has been electrified is removed.

In such a case, preferably, the recording apparatus is further provided with a drum along an outer peripheral surface of which the recording medium is fed, the aggregating agent applying section is configured and arranged to apply the aggregating agent to the recording medium at a first position on an outer peripheral surface feed path along the outer peripheral surface of the drum, and the ink discharge section is configured and arranged to discharge the ink onto the recording medium at a second position further on a downstream side of the feed path than the first position in the outer peripheral surface feed path along the outer peripheral surface of the drum.

According to this configuration, space can be conserved, it being possible to provide the aggregating agent applying section and the ink discharge section along the outer peripheral surface of the drum around which the recording medium is fed.

### BRIEF DESCRIPTION OF THE DRAWINGS

Referring now to the attached drawings which form a part of this original disclosure:

FIG. 1 is a configurational diagram of a recording apparatus in one embodiment of the present invention;

FIG. 2 is a perspective view about a rotating drum in a recording apparatus;

FIG. 3 is a drawing of head units in a recording apparatus;

FIG. 4 is a drawing illustrating a first embodiment of an aggregating agent applying section in a recording apparatus;

FIG. 5 is a drawing of an aggregating agent recovery section in a recording apparatus;

FIGS. 6A-6C are drawings illustrating the manner in which aggregating agent that has not reacted with ink and remains on a recording medium is recovered by an aggregating agent recovery section;

FIG. 7 is a drawing illustrating a second embodiment of the aggregating agent applying section; and

FIG. 8 is a configuration diagram of a recording apparatus as in another embodiment of the present invention.

### DETAILED DESCRIPTION OF EXEMPLARY EMBODIMENTS

A recording apparatus as in an embodiment of the present invention shall now be described below, with reference to the accompanying drawings. This recording apparatus is one where recording is performed by applying an aggregating agent that reacts with ink to an elongated recording medium, such as label paper, and discharging ink thereon. A variety of materials are available for use as a recording medium, such as papers or films.

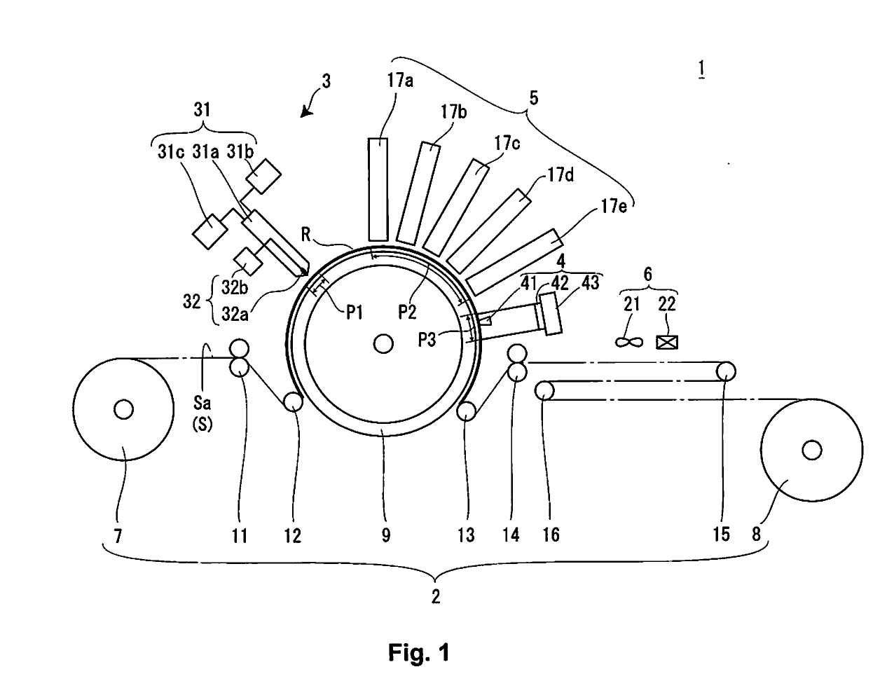

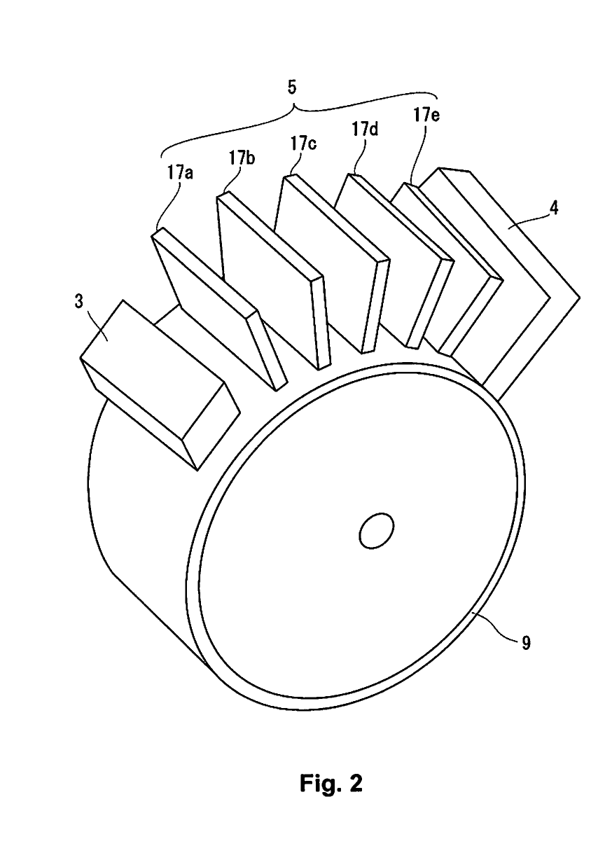

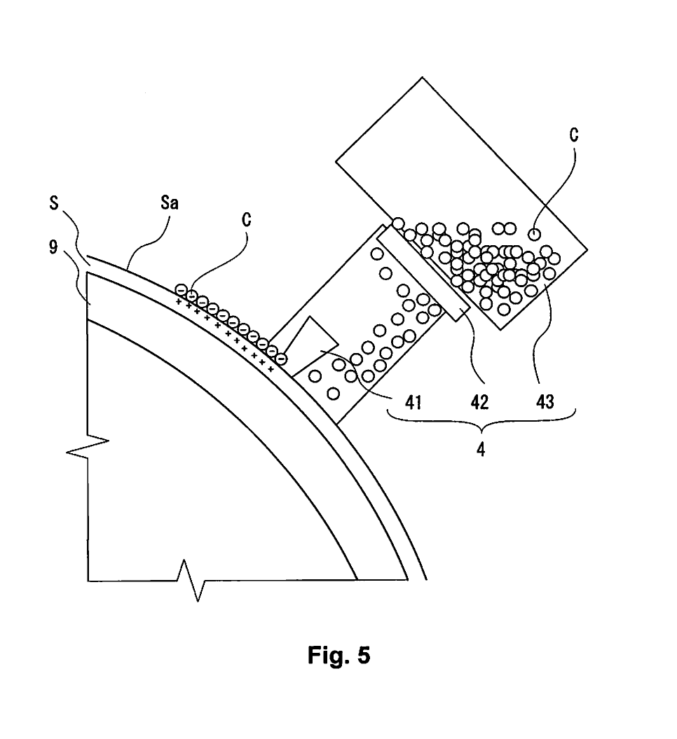

As illustrated in FIGS. 1 and 2, a recording apparatus 1 is provided with: a feed section 2 for feeding out a recording medium S; an aggregating agent applying section 3 for applying an aggregating agent C to the recording medium S (coating the recording medium S with the aggregating agent C) (see FIG. 5); an ink discharge section 5 for discharging ink onto to the recording medium S coated with the aggregating agent C; an aggregating agent recovery section 4 for suctioning from the recording medium S and recovering any of the aggregating agent C that remains on the recording medium S after the ink has been discharged from the ink discharge section 5; and a drying section 6 for drying the recording medium S onto which the ink has been discharged.

The feed section feeds out the recording medium S in a roll-to-roll format. The feed section 2 is provided with a supply reel 7, a take-up reel 8, a rotating drum 9 provided to substantially midway on a feed path, and a plurality of rollers provided to the feed path.

Provided as the plurality of rollers are an upstream feed roller 11, an upstream guide roller 12, a downstream guide roller 13, a downstream feed roller 14, a first loop-back roller 15, and a second loop-back roller 16, in the stated order from an upstream side in a direction of feeding. Rotatingly driving the supply reel 7, the upstream feed roller 11, the downstream feed roller 14, and the take-up reel 8 causes the recording medium S to be supplied from the supply reel 7, fed in the direction of feeding along the circumference of the rotating drum 9, and taken up at the take-up reel 8. The first loop-back roller 15 and the second loop-back roller 16 are provided to the drying section 6.

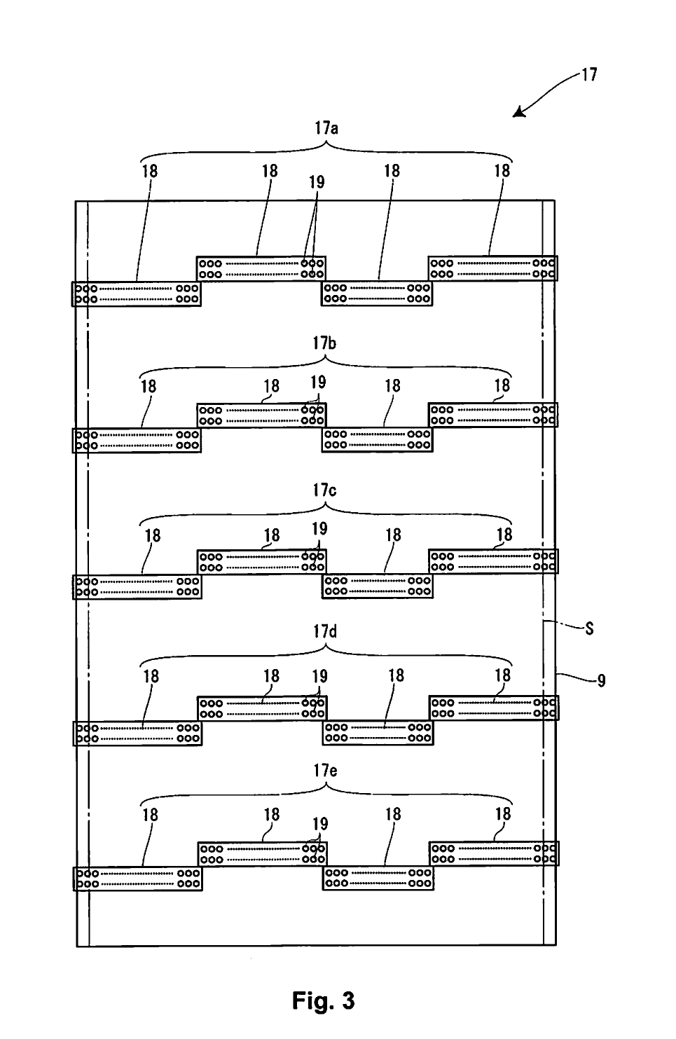

The rotating drum 9 is a cylindrical drum that is rotatably supported by a support mechanism (not shown). The rotating drum 9 supports the recording medium S on an outer peripheral surface from the reverse surface side, i.e., the opposite side to a recording surface Sa. When the recording medium S is fed along the outer peripheral surface thereof, the rotating drum 9 is rotatingly driven by the frictional force between the outer peripheral surface and the recording medium S. The dimension of the rotating drum 9 in the axial direction is slightly larger than the width of the recording medium S at the widest (see FIG. 3).

The name “outer peripheral surface feed path R” is given to the feed path along the outer peripheral surface of the rotating drum 9 out of the feed path of the recording medium S that reaches from the supply reel 7 to the take-up reel 8. FIG. 1 illustrates the outer peripheral surface feed path R with a solid thick line. The aggregating agent applying section 3 coats the recording medium S with the aggregating agent C at a first position P1 on the outer peripheral surface feed path R. The ink discharge section 5 discharges the ink onto the recording medium S at a second position P2, which is found more to the downstream side of the path than the first position P1, on the outer peripheral surface feed path R. The aggregating agent recovery section 4 suctions from the recording medium S and recovers the aggregating agent C that remains on the recording medium S at a third position P3 which is found more to the downstream side of the path than the second position P2, on the outer peripheral surface feed path R. This makes it possible to conserve space, it being possible to provide the aggregating agent applying section 3 and the ink discharge section 5 along the outer peripheral surface of the drum around which the recording medium S is fed.

The ink discharge section 5 is provided with a first head unit 17a, a second head unit 17b, a third head unit 17c, a fourth head unit 17d, and a fifth head unit 17e, in the stated order from the upstream side in the direction of feeding.

As illustrated in FIG. 3, each of the head units 17 is provided with, for example, four ink discharge heads 18. Each of the ink discharge heads 18 is one that discharges ink in an inkjet format, and has a plurality of ink discharge nozzles 19. The ink discharge nozzles 19 of the four ink discharge heads 18 are arranged so as to correspond to the width of the rotating drum 9. That is to say, each of the head units 17 is of the line type. This makes it possible for each of the head units 17 to discharge ink onto the entire width of the recording medium S without scanning in the width direction of the recording medium S, as is the case with the serial type.

The first head unit 17a discharges white ink. The second head unit 17b discharges black ink. The third head unit 17c discharges yellow ink. The fourth head unit 17d discharges cyan ink. The fifth head unit 17e discharges magenta ink. In a case where, for example, the recording medium S is constituted of a transparent film material, then the white ink is discharged by the first head unit 17a onto the entire surface to form an underlying layer of white, and then the respective colors of ink are discharged by the second head unit 17b through fifth head unit 17e onto the formed underlying layer, thus forming a color image. In a case where the recording medium S is constituted of a paper material, then no white ink need be discharged by the first head unit 17a, with the color image then being formed by the respective colors of ink discharged by the second head unit 17b through fifth head unit 17e.

It shall be readily understood that the colors of ink discharged by each of the head units 17 are not particularly limited. The number of the head units 17, i.e., the number of colors of ink discharged by the ink discharge section is likewise not particularly limited.

The inks discharged by each of the head units 17 are not particularly limited, provided that the inks react with the aggregating agent C with which coating is performed by the aggregating agent applying section 3; preferably, the inks are the result of dispersing a coloring material into a solvent. A suitably usable example of an ink with which a coloring material has been dispersed into a solvent is a pigment ink, in which a pigment is used as the coloring material.

The drying section 6 is provided between the rotating drum 9 and the take-up reel 8. The drying section 6 has a drying section fan 21 and a drying section heater 22, and dries the recording medium S by sending hot air, substantially in parallel with the recording surface Sa from the side, to the recording medium S onto which the aggregating agent C and the inks have been discharged. In the drying section 6, the feed path of the recording medium S is looped back by the first loop-back roller 15 and the second loop-back roller 16. For this reason, the hot air can be efficiently applied to the recording medium S without providing a wide space for the drying section 6.

The drying section 6 may dry the recording medium S by sending room-temperature air using only the drying section fan 21, or may dry the recording medium S by heating the recording medium S using only the drying section heater 22.

The aggregating agent applying section 3 coats the recording medium S with the aggregating agent C, which is in the form of a powder. The aggregating agent C is not particularly limited, provided that the aggregating agent C reacts with the inks discharged by each of the head units 17. In a case where an ink with which a coloring material has been dispersed into a solvent is used, then preferably the aggregating agent C is an aggregating agent C that aggregates the coloring material.

When inks with which a coloring material has been dispersed into a solvent are discharged onto the recording medium S having been coated with the aggregating agent C, then the aggregating agent C neutralizes the force of Coulomb's repulsion across the coloring materials, and thus causes the coloring materials to aggregate together. This thickens the inks discharged onto the recording medium S, and raises the fixability of the inks to the recording medium S.

The reaction between the aggregating agent C and the inks is in no way limited to being the above-described aggregation of coloring materials by the aggregating agent C.

A preferable example of the aggregating agent C would be a metal salt; in particular, polyvalent metal salts are preferable in terms of strength of aggregation. Suitably usable examples of polyvalent metal salts include one or a plurality from among calcium nitrate, calcium chloride, magnesium chloride, calcium acetate, magnesium acetate, and calcium formate. The particle size of the aggregating agent C is preferable 20 to 100 μm, and the coated amount is preferably 25 to 80 mg/m2.

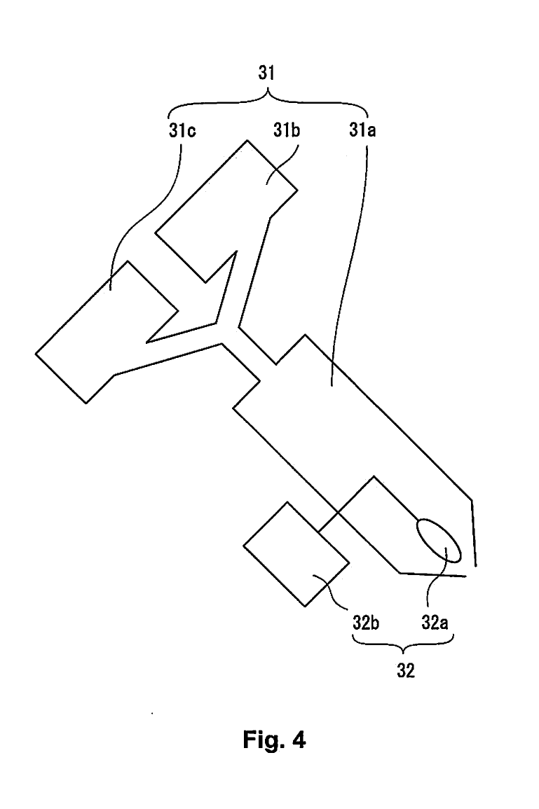

As illustrated in FIG. 4, the aggregating agent applying section 3 uses an electrostatic spraying approach and is provided with an aggregating agent spraying section 31 for spraying the aggregating agent C in powder form toward the recording medium S and an electrifying section 32 for electrifying the aggregating agent C.

The aggregating agent spraying section 31 is constituted of a spray gun 31a for spraying the aggregating agent C onto the recording medium S, a compressed air supply section 31b for supplying compressed air to the spray gun 31a interior, and an aggregating agent supply section 31c for supplying the aggregating agent C to the spray gun 31a interior.

The electrifying section 32 is of a corona electrification type. The electrifying section 32 is provided with an electrode 32a provided to near a tip of the spray gun 31a, and a high voltage generator 32b for applying a high voltage (for example, −40 to −90 kV) to the electrode 32a.

The aggregating agent C sprayed from the spray gun 31a is electrified by the corona discharge of the electrode 32a, and attached to the grounded recording medium S by electrostatic forces. Providing the electrifying section 32 causes the electrified aggregating agent C to be attracted to the recording medium S, due to electrostatic attraction. This makes it possible to efficiently coat the recording medium S with the aggregating agent C. Also, the entire width of the recording medium S can be coated with the aggregating agent C. In the present embodiment, the electrifying section 32 that is used is of a corona electrification format, but there is no limitation thereto, and the electrifying section 32 may be of, for example, a frictional electrification format.

As illustrated in FIG. 5, the aggregating agent recovery section 4 is provided with an anti-static brush 41 (neutralizing section) for removing the static electricity of the aggregating agent C, a suction fan 42 for suctioning the aggregating agent C, and an aggregating agent recovery box 43 for recovering the aggregating agent C.

The anti-static brush 41 has a length corresponding to the width of the recording medium S. Having been neutralized by the anti-static brush 41, the aggregating agent C is suctioned by the suction fan 42 and recovered to the aggregating agent recovery box 43.

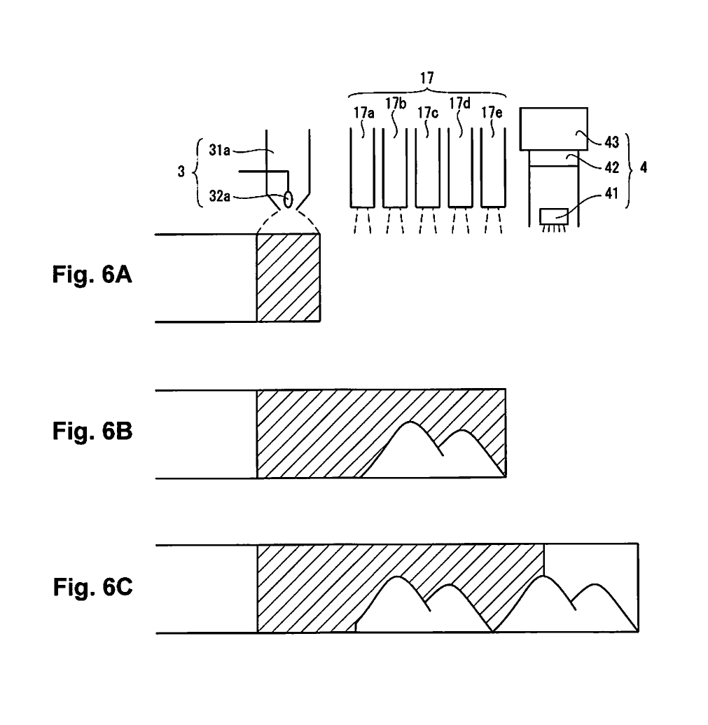

FIG. 6 describes the manner in which the aggregating agent C with which the recording medium S has been coated but which has not reacted with the ink and remains on the recording medium S is recovered by the aggregating agent recovery section 4.

First, the entire surface of the recording medium S is coated with the aggregating agent C by the spray gun 31a (see FIG. 6A).

Next, the inks are discharged in part onto the recording medium S by the ink discharge section 5. At the places where the ink was not discharged, the aggregating agent C remains without having reacted with any ink (see FIG. 6B).

The aggregating agent C remaining on the recording medium S is recovered by the aggregating agent recovery section 4. This causes only aggregated ink to remain on the recording medium S after the aggregating agent C has been recovered (see FIG. 6C).

As described above, according to the present embodiment, the remaining aggregating agent C can be recovered by the aggregating agent recovery section 4. The anti-static brush 41 makes it possible to efficiently recover the aggregating agent C remaining on the recording medium S, because the static electricity with which the aggregating agent C is charged is removed thereby. The removal of the charged static electric need not be done by the anti-static brush 41.

Next, a second embodiment of the aggregating agent applying section 3 shall be described. The aggregating agent applying section 3 of the first embodiment was of an electrostatic spraying approach, whereas the aggregating agent applying section 3 of the second embodiment is of an electrostatic fluidized bed coating approach.

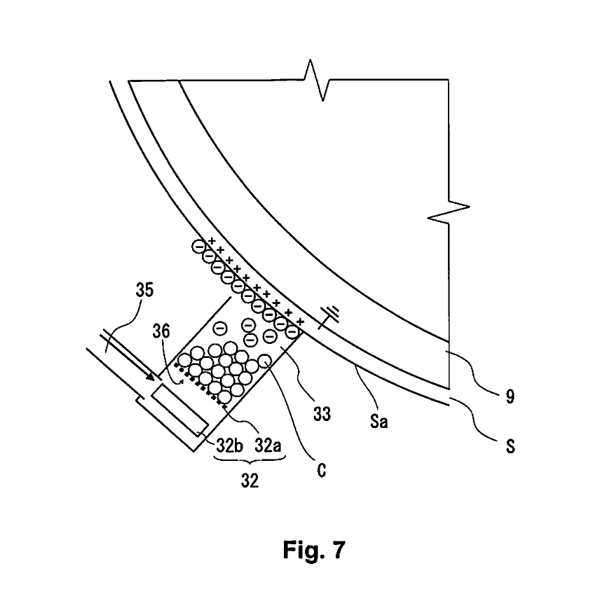

As illustrated in FIG. 7, the aggregating agent applying section 3 is provided facing obliquely upward so that a release opening opposes the outer peripheral surface of the rotating drum 9, and is provided with an aggregating agent storage tank 33 storing the aggregating agent C in a powder form, the electrifying section 32 for electrifying the aggregating agent C, a perforated plate 36 provided to the bottom of the aggregating agent storage tank 33, and an air supply path 35 for supplying air to inside the aggregating agent storage tank via the perforated plate 36.

The electrifying section 32 is provided with the electrode 32a, which is provided to the perforated plate 36, as well as with the high voltage generator 32b for applying a high voltage (for example, −30 to −100 kV) to the electrode 32a.

The aggregating agent C is fluidized inside the aggregating agent storage tank 33 by the air that is sent from the air supply path 35, and is electrified by the corona discharge of the electrode 32a. This causes the aggregating agent C to float inside the aggregating agent storage tank 33 while the powder particles of the aggregating agent C repulse one another on account of having the same charge, and causes the aggregating agent C to attach to the grounded recording medium S because of electrostatic force.

As described above, the aggregating agent applying section 3 of the second embodiment also allows for providing the electrifying section 32 to cause the electrified aggregating agent C to be attracted to the recording medium S by electrostatic attraction. This makes it possible to efficiently coat the recording medium S with the aggregating agent C.

As described above, according to the recording apparatus 1 of the present embodiment, coating the recording medium S with the aggregating agent C in the form of a powder makes it possible to apply the aggregating agent C to the recording medium S without having to apply a treatment liquid that contains the aggregating agent C to the recording medium S.

As such, the need for a step for drying a recording medium S, which has been performed in instances where a treatment liquid was applied to the recording medium S, is obviated. As a consequence, the manufacturing costs and running costs needed for the dry step can be reduced, and also the overall size of the recording apparatus 1 can be reduced.

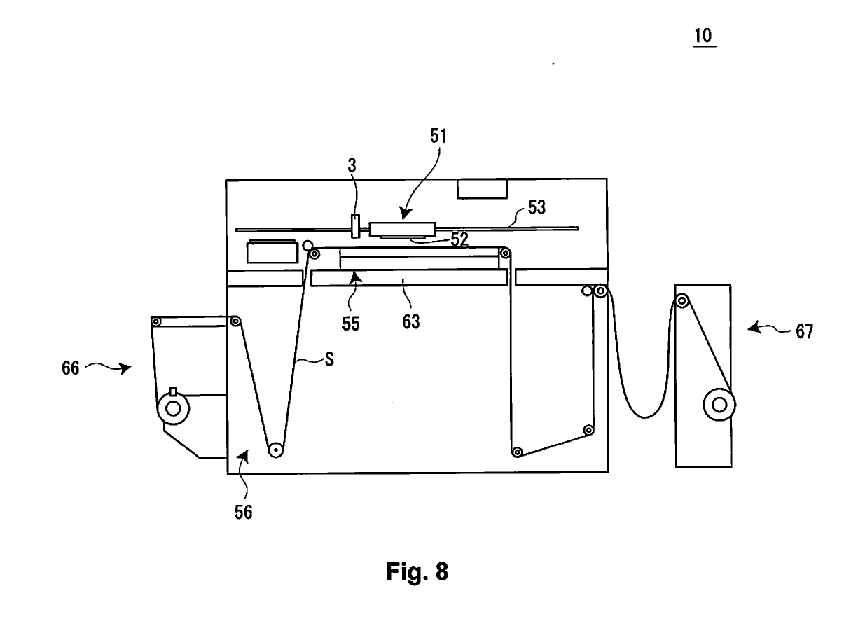

The present embodiment describes an example where the present invention is applied to the recording apparatus 1 of a drum conveyance type, but there is no limitation thereto, and the present invention could also be applied a recording apparatus 10 of a flat conveyance type, such as is illustrated in FIG. 8. This recording apparatus 10 has: the aggregating agent applying section 3 for coating the recording medium S with the aggregating agent C in the form of a powder; a carriage unit 51 having a plurality of recording heads 52 constituted of inkjet heads; an X-axis table 53 for moving the carriage unit 51 in the X-axis direction, which is the direction of feeding of the recording medium S; a Y-axis table (not shown) that is mounted onto the X-axis table 53 and moves the carriage unit 51 minutely in the Y-axis direction; a platen 55 that is disposed atop a baseplate 63 so as to face the carriage unit 51; and a paper feed mechanism 56 by which the recording medium S is fed in to the platen 55 from a supply section 66 while simultaneously also being fed out to a take-up section 67 from the platen 55.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. A recording apparatus, comprising:
an aggregating agent applying section configured and arranged to apply an aggregating agent in a form of a powder to a recording medium; and
an ink discharge section configured and arranged to discharge ink onto the recording medium to which the aggregating agent applying section has applied the aggregating agent such that the ink discharged on the aggregating agent reacts with the aggregation agent to be aggregated.

2. The recording apparatus as set forth in claim 1, wherein
the aggregating agent applying section has an electrifying section configured and arranged to electrify the aggregating agent.

3. The recording apparatus as set forth in claim 1, wherein
the aggregating agent applying section has an aggregating agent spraying section configured and arranged to spray the aggregating agent toward the recording medium.

4. The recording apparatus as set forth in claim 1, further comprising
an aggregating agent recovery section configured and arranged to suction and recover from the recording medium the aggregating agent that remains on the recording medium after the ink has been discharged from the ink discharge section.

5. The recording apparatus as set forth in claim 4, wherein the aggregating agent recovery section has a neutralizing section configured and arranged to remove static electricity with which the aggregating agent has been electrified.

6. The recording apparatus as set forth in claim 1, further comprising
a drum along an outer peripheral surface of which the recording medium is fed,
the aggregating agent applying section being configured and arranged to apply the aggregating agent to the recording medium at a first position on an outer peripheral surface feed path along the outer peripheral surface of the drum, and
the ink discharge section being configured and arranged to discharge the ink onto the recording medium at a second position further on a downstream side of the feed path than the first position in the outer peripheral surface feed path along the outer peripheral surface of the drum.

7. A recording method, comprising:
applying an aggregating agent in a form of a powder to a recording medium; and
discharging ink onto the recording medium to which the aggregating agent has been applied such that the ink discharged on the aggregating agent reacts with the aggregation agent to be aggregated.

8. The recording apparatus according to claim 1, further comprising:
a feed section configured and arranged to transfer the recording medium in a feeding direction, wherein
the aggregating agent applying section is arranged upstream in the feeding direction relative to the ink discharge section.

9. The recording apparatus according to claim 2, wherein
the electrifying section is configured and arranged to electrify the aggregating agent in the aggregating agent applying section, and the aggregating agent applying section is configured and arranged to apply the aggregating agent that has been electrified to the recording medium.
